(19) United States
(12) Patent Application Publication
(10) Pub. No.: US 2022/0198167 A1
(43) Pub. Date: Jun. 23, 2022

(54) METHOD AND SYSTEM FOR REGISTERING AND AUTHENTICATING ITEMS

(71) Applicant: Kim Hoi SO, Hong Kong (CN)

(72) Inventor: Kim Hoi SO, Hong Kong (CN)

(21) Appl. No.: 17/552,850

(22) Filed: Dec. 16, 2021

(30) Foreign Application Priority Data
Dec. 21, 2020 (CN) 202011520953.2

(51) Int. Cl. G06K 7/14; G06K 7/10

(52) U.S. Cl. CPC G06K 7/1417; G06K 7/10445; G06K 7/10297

(57) ABSTRACT

The present invention provides a method and system for registering and authenticating items. The method can include steps of: receiving a login information of a user; identifying a unique physical identifier (UPI) associated with the item to obtain a registered ownership record associated with the item and the UPI, where ownership of the item is to be transferred by the user; matching the login information of the user with the ownership record of the item for authentication of the item; where if the ownership record and the login information do not match, the authentication is determined as being unsuccessful. Also provided herein is a system and method for registering and authenticating any physical object, which system and method may have particular value in authenticating personal objects of high value and items created by designer brands and artists. Information on authenticating user identity and the item as well as entire ownership and creation information may be stored in a blockchain based registry, where information of the present invention cannot be tampered.

### CROSS REFERENCE TO RELATED APPLICATION

This application claims priority to China invention patent application no. 202011520953.2 filed on 21 Dec. 2020, which is incorporated herein by reference.

### FIELD OF THE INVENTION

The present invention relates to systems and methods for authenticating physical objects. More specifically, the present invention is related to a system and method for reliably and securely registering an object and associating with a unique physical identifier.

### SUMMARY OF THE INVENTION

The first aspect of the present invention provides a method of authenticating an item, the method comprising receiving a login information of a user; identifying a unique physical identifier (UPI) associated with the item to obtain a registered ownership record associated with the item and the UPI, wherein ownership of the item is to be transferred by the user; and matching the login information of the user with the ownership record of the item for authentication of the item; wherein if the ownership record and the login information do not match, the authentication is determined as being unsuccessful.

In one or more embodiments, if the authentication is determined as being unsuccessful, the method further comprises steps of: sending an alert to an owner of the item as registered in the ownership record; receiving ownership credential from the user; and adding the ownership credential to the ownership record such that the ownership record and the login information match.

In one or more embodiments, if the authentication is determined as being unsuccessful, the method further comprises searching, in a system database, to determine whether the item has been reported lost; if the item has been reported lost in the system database, sending a notification to the user which notifies the owner of the item as registered in the ownership record that the item has been found; and if the item has not been reported lost in the system database, sending an alert to the owner of the item as registered in the ownership record, receiving ownership credential from the user; and adding the ownership credential to the ownership record such that the ownership record and the login information match.

In one or more embodiments, if the ownership record and the login information match, the method further comprises adding ownership information of a new owner to the registered ownership record of the item, such that the new owner becomes current owner of the item.

In one or more embodiments, the UPI of the item is registered through steps comprising generating the UPI according to physical identification information associated with the item and associating the UPI with the item being registered; generating, based on the UPI, a new product information data block corresponding to the item being registered and permanently storing the new product information data block in a registry used for recording ownership history of the item.

In one or more embodiments, the ownership record of the item associated with the UPI is registered through steps comprising receiving, from the user, a registration request; obtaining, from the user, item information associated with the UPI; generating the UPI according to physical identification information associated with the item and the item information, and associating the UPI with the item being registered; and generating, based on the UPI, a new product information data block corresponding to the item being registered and ownership of the user and permanently storing the new product information data block in a registry used for recording ownership history of the item.

In one or more embodiments, the UPI comprises a QR code, a RFID, or a product serial number.

In one or more embodiments, the ownership record of the item is stored in a blockchain, each ownership history forming an ownership chain.

In one or more embodiments, the step of receiving is performed by a first computer and the steps of identifying and matching are performed by a second computer.

In one or more embodiments, the first computer is a smartphone or a mobile tablet.

In one or more embodiments, the second computer includes a blockchain network.

A second aspect of the present invention provides a method of registering an item comprising the steps of providing the item; receiving, by a first computer and from a user, a registration request; obtaining, from the user, item information associated with a unique physical identifier (UPI); generating, by a second computer, the UPI according to physical identification information associated with the item and the item information and associating the UPI with the item to be registered; generating, by the second computer and based on the UPI, a new product information data block corresponding to the item to be registered and ownership of the user and permanently storing the new product information data block in a registry used for recording ownership history of the item.

A third aspect of the present invention provides a system for authenticating an item, comprising: the item; a login information from a user; a unique physical identifier (UPI) associated with the item to obtain a registered ownership record associated with the item and the UPI, wherein ownership of the item is to be transferred by the user; and a computer for matching the login information of the user with the ownership record of the item and for determining the authentication is unsuccessful if the ownership record and the login information do not match.

A fourth aspect of the present invention provides a computer readable storage medium. The storage medium stores a computer program, when the computer program is being executed any one of the methods described above is implemented.

### BRIEF DESCRIPTION OF THE DRAWINGS

FIG. 1 is a method for generating a unique physical identification in accordance with an embodiment of the invention.

FIG. 2 is a method for generating a unique physical identification in accordance with an embodiment of the invention.

FIG. 3 is a method for generating a unique physical identification in accordance with an embodiment of the invention.

FIG. 4 is a method for updating a registry in accordance with an embodiment of the invention.

FIG. 5 is a method for updating a registry in accordance with an embodiment of the invention.

FIG. 6 is a method for authenticating an object in accordance with an embodiment of the invention.

FIG. 7 is a method for authenticating an object in accordance with an embodiment of the invention.

FIG. 8 is a method for authenticating an object in accordance with an embodiment of the invention.

FIG. 9 is a method for insuring an authenticated object in accordance with an embodiment of the invention.

FIG. 10 is a block diagram of the process of adding information to the ledger in accordance with an embodiment of the invention.

FIG. 11 is a flow chart of the method of authenticating an item in accordance with an embodiment of the invention.

FIG. 12 is a flow chart of the method of registering an item in accordance with an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system and method for associating a physical object with a unique identifier and authenticating same. The system may be adapted to provide a reliable history, for both the origination and ownership history, of a physical object. The history may be added to a registry and retrieved by potential buyers to authenticate the item and confirm legitimacy of the seller. This inventive system and method may be utilized to authenticate any physical object and may have particular value in authenticating personal objects of high value and items created by designer brands and artists. The authenticating information and entire ownership and creation information may be stored in the registry virtually immune to tampering due to the utilization of blockchain technology.

After initially creating a record of ownership in the registry, all subsequent changes in ownership may be tracked and recorded in the registry. The inventive system and method may utilize the combination of a unique physical identification (UPI) with proof of current ownership in the registry to authenticate that (1) the item in genuine and (2) the person in possession of the item is the legitimate owner.

The UPI may refer to a physical identifier associated with each object. The UPI may have some attribute or combination of attributes that makes it unique. Each UPI may be associated with exactly one item. By way of example, and not as a limitation, the UPI may be a QR code, RFID, or the like. The UPI may be permanently embedded in the object (e.g., RFID), permanently printed on the item (e.g., QR code), permanently affixed to the item, or an existing serial number assigned to the object in combination with the brand associated with the object. Identifying information may be associated with each UPI and stored in a centralized or decentralized ownership registry. Identifying information associated with each UPI may include, but is not limited to, the originator of the object, complete ownership history, model of the object, images of the object, and description of the object.

The present method and system may have different features available to different classes of users. Users may be grouped into three different classifications. By way of example, and not as a limitation, users in a first classification may be brand owners, artists, or others who create objects. By way of example, and not as a limitation, users in a second classification may be museum, auctions houses, or others who have met some level of credentialing, but do not create objects. By way of example, and not as a limitation, users in a third classification may be members of the general public or organizations that have not been credentialed. Members of each of the three classifications may be able to enroll a physical object into the registry using different methods.

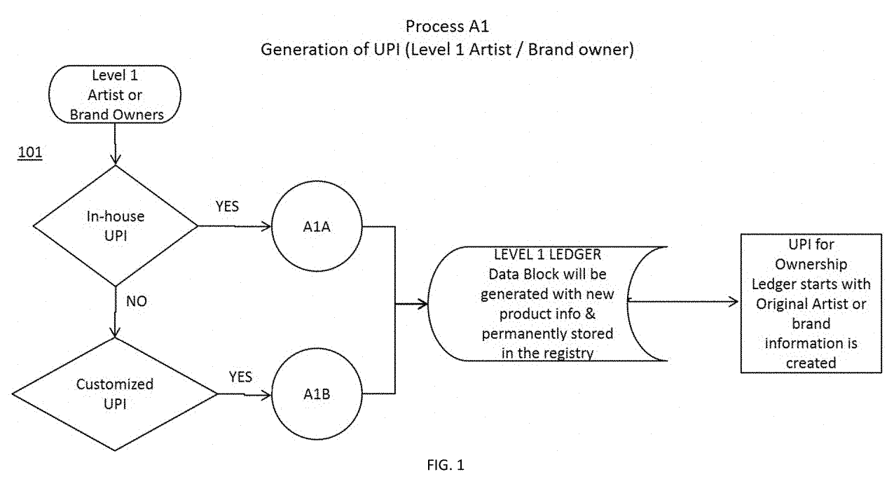

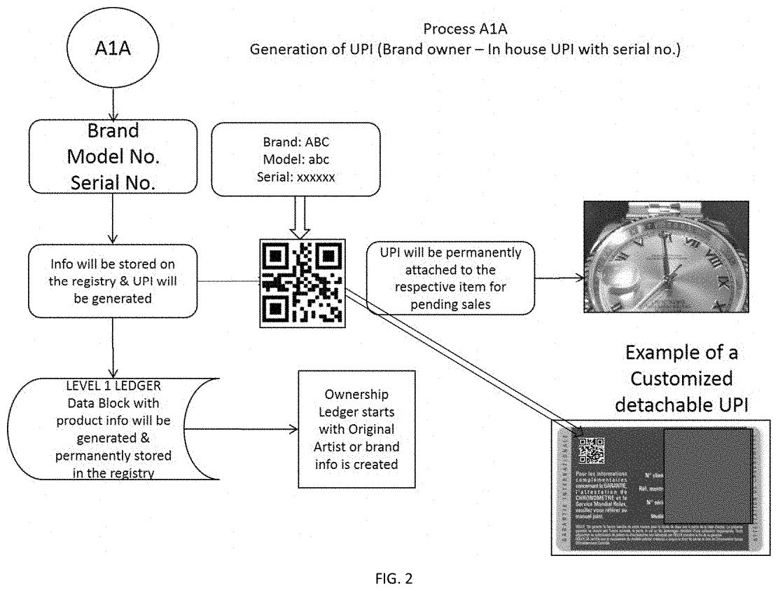

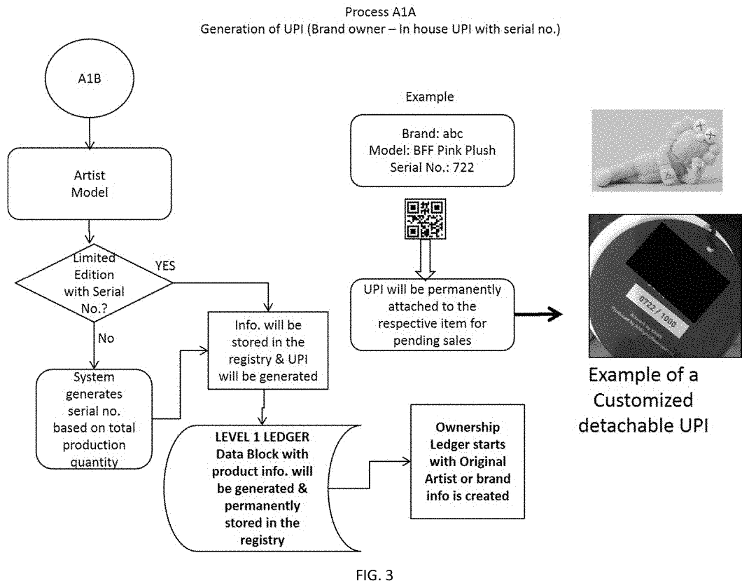

As shown in FIG. 1, members of the first classification may generate a unique physical identifier (UPI) and update the ownership history in the registry. At a first step in the process, step 101, the user may decide whether to use an in-house UPI or a custom UPI. In embodiments in which an in-house UPI will be utilized, the method may proceed through method A1A, as depicted in FIG. 2 to create the UPI. In embodiments in which a custom UPI will be utilized, the method may proceed through method A1B, as depicted in FIG. 3 to create the UPI. Returning to FIG. 1, After creation of the UPI, the information associated with the UPI will be added to the registry and the UPI will be physically associated with the object. The registry may be stored in a blockchain.

Turning to FIG. 2, method A1A is depicted, which may be used by a first classification of users to create an in-house UPI. An in-house UPI may combine unique identifying information with some other physical product associated with the object. By way of example, and not as a limitation, an in-house UPI may include a QR code placed on an objects warranty card. The information associated with an in-house UPI may include, but is not limited to, brand, model number, and serial number. This information may be associated with the UPI and the UPI may be permanently attached to or detachable from the object. The information associated with the UPI may be stored in the registry as the original ownership information.

Turning to FIG. 3, method A1B is depicted in which a customizable UPI may be created. The information associated with a customizable UPI may include, but is not limited to, artist and model. In embodiments in which the object associated with a customizable UPI is a limited edition with a serial number or otherwise has a unique identifier, this information may also be associated with the UPI. The UPI may be permanently attached to or detachable from the object. The information associated with the UPI may be stored in the registry as the original ownership information.

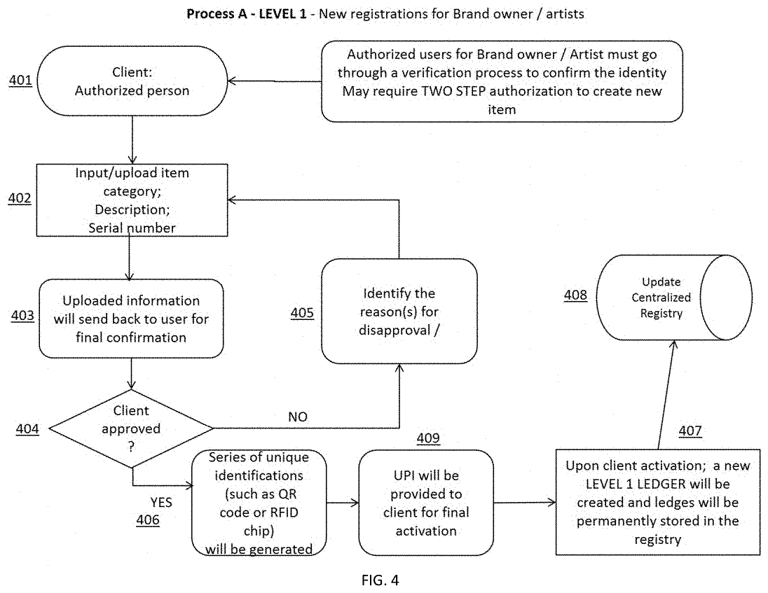

Turning to FIG. 4, this method may be employed to create an entry in the registry. In step 401, an authorized person may initiate a product registration. The authorized person may go through a verification process to confirm their identity or their credible association with the original producer of the product. In some embodiments, a two-step verification process may be used to confirm the identity or association of the authorized person. Once the authenticity of the authorized person is verified, in step 402 the authorized person may provide information to be associated with the UPI. The information may be received by the system and presented to the authorized user for verification in step 403. The authorized user may approve or disapprove of the data as presented by the system in step 404. If the information is not approved, the authorized user may be given an opportunity to correct the information or identify reasons for disapproval in step 405. The authorized user may then proceed to step 402 or 403 and continue to step 404 to be given another opportunity to approve or disapprove of the information associated with the UPI. Upon approval of the information, the authorized user may proceed to step 406, in which a UPI will be generated. Upon generation of the UPI, the UPI may be provided to the authorized user and the authorized user may be required to activate the UPI in step 409 prior to creation of a new entry in the ledger. In step 407, after activation of the UPI by the authorized user, a new entry will be created for the registry to associate the UPI with the information provided. In step 408, this entry will be added to the registry, which may be stored in blockchain. Steps 406, 407, and 408 may be presented in more detail in FIGS. 2 and 3. The method depicted in FIG. 4 may be utilized by members of any classification of user. UPIs may be created in accordance with the methods of either FIG. 2 or 3, dependent upon the classification of the user creating the UPI.

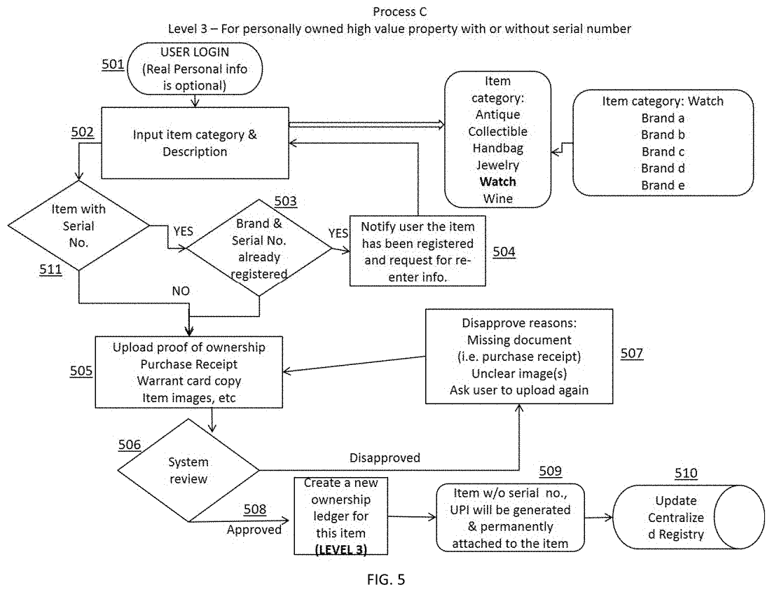

Turning to FIG. 5, this method may be employed to create an entry in the registry. This method may be used when the person creating the entry is creating separate UPI, is utilizing a serial number, or is utilizing another unique identifier associated with the product by the original manufacturer of the product. In such an embodiment, the separately created UPI, serial number, or other unique identifier may be referred to as a UPI. The method depicted in FIG. 5 may be employed by anyone owning or in possession of a high value item or other item desired to be entered into the registry. In step 501, any person may initiate a product registration by logging in. Personally identifying information may be required to create login credentials. By way of example, and not as a limitation, the person creating login credentials must be authenticated before the login information can be created. In one embodiment, the identity of the user may remain anonymous and the owner of the object may be associated with the UPI by login credentials and not by personally identifying information. The authorized person may go through a verification process to confirm their identity. Once the authorized person is logged in to the system, in step 502 the authorized person may provide information, as well as the serial number, if applicable, with which the information is to be associated. The information provided to the system may vary based on the object. In embodiments in which the object is a watch, brand information and serial number may be provided. By way of example, and not as a limitation, different information may be required or selectable dependent upon whether the object is an antique, collectible, handbag, jewelry, watch, wine, or the like. Upon providing the required information, the system may determine in step 511 whether or not a serial number was provided. If a serial number was provided, in step 503, the system may determine if the serial number has already been registered with the system. If the information has already been registered, the user may be notified of this in step 504. The user may then proceed back to step 502 for the opportunity to reenter information and the serial number with which to associate the information. If the serial number has not already been registered or no serial number was provided, the system may proceed to step 505, in which the user must upload proof of ownership of the object associated with the serial number. Such proof of ownership may be provided by a purchase receipt, warranty card, image of the object, or the like. Upon receipt of this proof of ownership, in step 506 the information may be received by the system and reviewed. If the system reviews and disapproves of the proof of ownership, the authorized user may be notified of the disapproval in step 507 and given an opportunity to correct the information or provide additional proof of ownership in step 507 or 505. Upon approval of the information, the authorized user may proceed to step 508, in which a new entry will be created for the registry to associate the serial number, or other unique identifier, which may include, but is not limited to, a UPI, with the information provided. In step 509, in the event a serial number or other unique identifier is not available, a UPI may be created and permanently affixed to the object. Step 509 may utilize a manufacturer's serial number, or other unique identifier provided by the manufacturer, in place of a newly generated UPI when this information is available. In step 510, this entry will be added to the registry, which may be stored in blockchain. Step 509 may be presented in more detail in FIGS. 2 and 3.

FIGS. 4 and 5 relate to initial registration of an object on the registry. Inherent in these initial registrations is an identification of the initial owner of the object. For any ownership change occurring after the initial registration, the information associated with the UPI must be updated and the registry must be updated accordingly. The registry may be updated by creation of a new ownership block, which will be linked to the current ownership block. It is important to note that ownership information is never deleted, but additional ownership information may be added. The registry may be updated when ownership of the object changes.

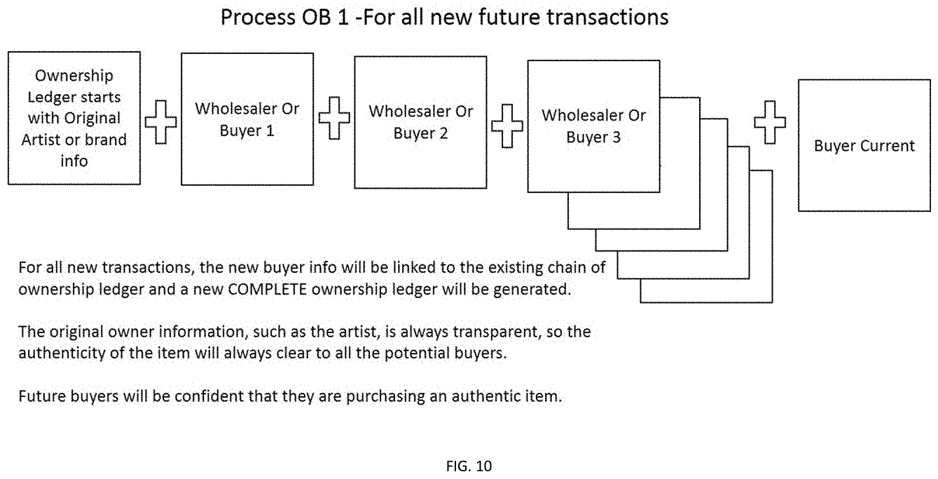

As shown in FIG. 10, new buyer owner is linked to the existing chain of ownership stored in the ledger and a new complete ownership ledger is generated each time ownership is changed. The original owner information, including the initial source of the object is never removed and remains transparent, which allows the authenticity of the object to be clear to a potential buyer. This chain of ownership may be maintained by utilizing block chain technology. The use of block chain technology may prevent tampering with previously provided information or changing current information stored in the block chain. The use of block chain technology is well understood by one having ordinary skill in the art.

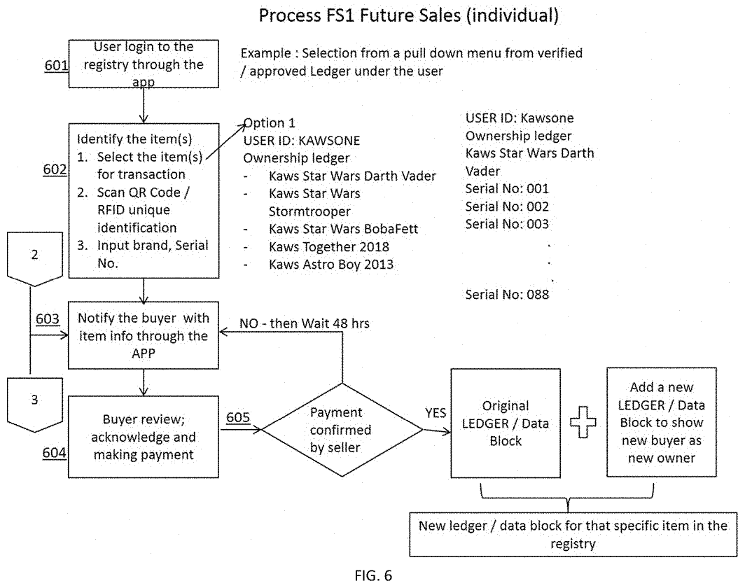

Turning to FIG. 6, to initiate an update to the registry, the current owner, as identified in the registry, must log in to the system or otherwise be verified as the current owner of record in accordance with step 601. The system may present the user with a list of all items for which they are currently identified as the owner. In step 602, the user may select the object whose ownership is to be transferred. The user to whom ownership is to be transferred may be identified and the system may notify them of the pending transfer of ownership in step 603. Upon notification of the pending transfer, the new owner may review the terms of transfer, acknowledge the transfer, and/or make payment in step 604. The system may then, in step 605, wait for the seller to confirm that payment has been received or may independently confirm that payment has been provided to seller. Once payment is confirmed, the new owner information may be appended to the existing information in the registry, which is already associated with the UPI.

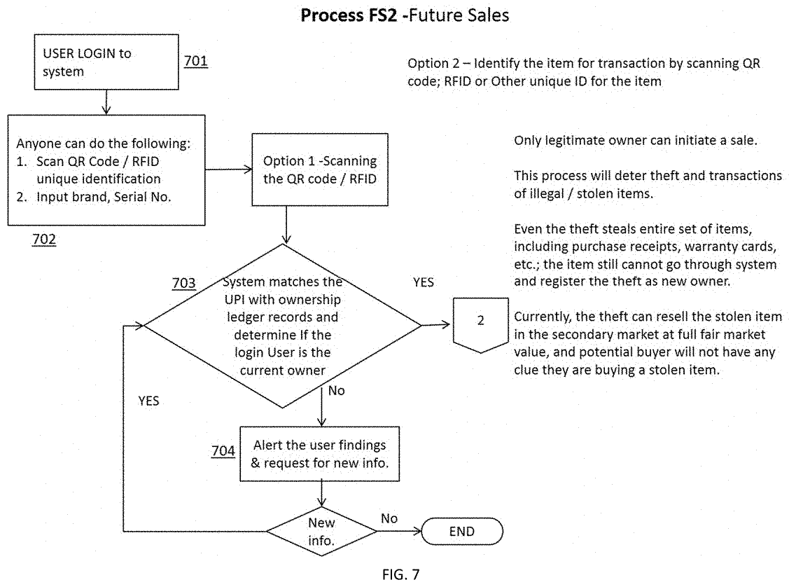

FIG. 7 presents a method for authenticating a sale of an item. The method depicted in FIG. 7 may be used in conjunction with the method of FIG. 6. In this method, the current owner, as identified in the registry, may log in to the system 701. In step 702, the user may select an item that is to be sold. This item may be selected by scanning information found on the UPI (e.g. RFID, QR Code) or entering identifying information associated with the UPI (e.g. serial number). In step 703, the system may check the ownership information of the UPI identifier entered by the user. If the ownership information matches the user's login information, the transfer of ownership may proceed to step 603 of the method depicted in FIG. 6. If the ownership information does not match the user's login information, in step 704, the system may alert the owner of record and the user of the system. The method of FIG. 7 may be used by a potential buyer to authenticate the owner of an object. In such an embodiment, it would be expected that the owner of record information would not match the login information of the user and the owner of record may be reported to the user in step 704. If the user has sufficient credentials to be trusted by the system, the user may update ownership records. Provided the user has sufficient credentials, the user may provide updated ownership information in step 705, which will then be added to the registry. Allowing trusted users to update ownership information may facility the sale of transactions through brokers or professional sellers.

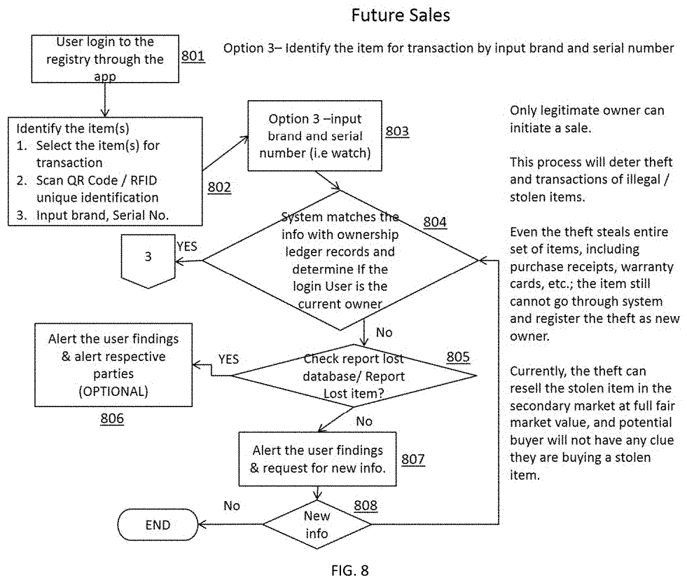

FIG. 8 presents another method for authenticating a sale of an item. The method depicted in FIG. 8 may be used in conjunction with the method of FIG. 6. In this method, the current owner, as identified in the registry, may log in to the system 801. In step 802, the user may select an item that is to be sold. This item may be selected by scanning information found on the UPI (e.g. RFID, QR Code) or entering identifying information associated with the UPI (e.g. serial number). In step 804, the system may check the ownership information of the UPI identifier entered by the user. If the ownership information matches the user's login information, the transfer of ownership may proceed to step 603 of the method depicted in FIG. 6. If the ownership information does not match the user's login information, in step 805, the system may check a system database to determine if the object has been reported lost. If the item has been reported lost, in step 806 the system may report to this fact to the user of the system and also report to the owner of record that the object has been found. If the item has not been reported lost, but the user who is logged in does not match the owner of record, the system may alert the owner of record and the user of the system in step 807. The method of FIG. 8 may be used by a potential buyer to authenticate the owner of an object. In such an embodiment, it would be expected that the owner of record information would not match the login information of the user and the owner of record may be reported to the user in step 807. If the user has sufficient credentials to be trusted by the system, the user may update ownership records. Provided the user has sufficient credentials, the user may provide updated ownership information in step 808, which will then be added to the registry. Allowing trusted users to update ownership information may facility the sale of transactions through brokers or professional sellers.

In yet another embodiment, a UPI may be queried by any user of the system. The UPI may be entered into the system for a query by scanning, keyboard entry, or the like. The system may retrieve a record associated with the UPI to determine whether or not the item has been reported lost, stolen, or the like, In the event the item has been reported lost, stolen, or the like, the user scanning the item may be notified of the status of the item and the owner of record of the item may be notified that the UPI has been scanned. The owner of record may be notified by email, SMS, text message, phone call, or the like.

It should be appreciated that methods and systems described herein include suitable hardware for enacting the methods and as part of the systems. For example, methods and systems described herein may include a first computer, which may also be referred to as a user computer, and a second computer, which may also be referred to as a central computer or database computer. The user computer may be utilized by the user for one or more of the method steps described herein. The central computer may be utilized for one or more of the method steps described herein after receiving the input from the first computer. The user computer and the central computer will include suitable software, which design thereof will be generally known to the skilled person in accord with the present description, for enacting the methods and as part of the systems.

The user computer may be a mobile device such as a smartphone or a mobile tablet. The user computer may include one or more of the following features for carrying out one or more of the method steps described herein: i) a scanning function, which can scan the UPI (e.g. QR code) or for performing facial recognition; ii) a photo-taking function, which can take images of the subject matter (e.g. UPI and/or item) for future storage and recognition; and iii) a near field communications (NFC) function, which can communicate with any latest in-house authentication features. As examples, these one or more features may be used for one or more of the following steps of the methods described herein: receiving login information and/or ownership credential of a user; scanning/identifying UPI associated with the item being authenticated/registered; obtaining information of the item being authenticated/registered.

As suggested above, the user computer is in suitable communication with the central computer such that the user computer serves as an input to the central computer. As mentioned above, this includes the use of suitable software that connects and transfers the input from the user computer (e.g. mobile device) to the central computer (e.g. blockchain network and system storage) such that the input can remain on the central computer for all future transactions and authentication process. As examples, the data being input from the user computer to the central computer can include: the login information and credential information of users; the UPI and information of the items being authenticated/registered; the ownership record of the items; and the results of matching the login information of a user with the ownership record.

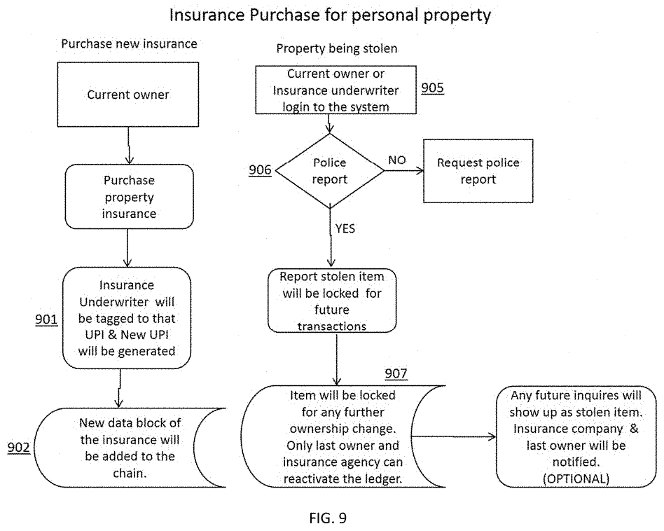

The use of the present system and methods may reduce fraudulent transfers by creating a mechanism for authenticating sellers and elimination, or at least reducing, the market for counterfeit or unlawfully obtained products. The present system and method may also be used by insurance underwriters. An insurer may be added to the registry and any ownership changes or inquiries may be reported to the insurer. As depicted in FIG. 9, when an owner of record purchase insurance on the object associated with the UPI, the insurance information may be added to the information associate with the registry in steps 901 and 902. In the event that the object is stolen, a user may login to the system in step 905. Provided a police report is available, as determined at step 906, the registry may be locked for changes and ownership information may only be changed with approval of both the owner of record and the insurer, as shown in step 907.

The various embodiments of the present invention provide a method of authenticating items, a method of registering items, a system for authenticating items and a computer readable storage medium.

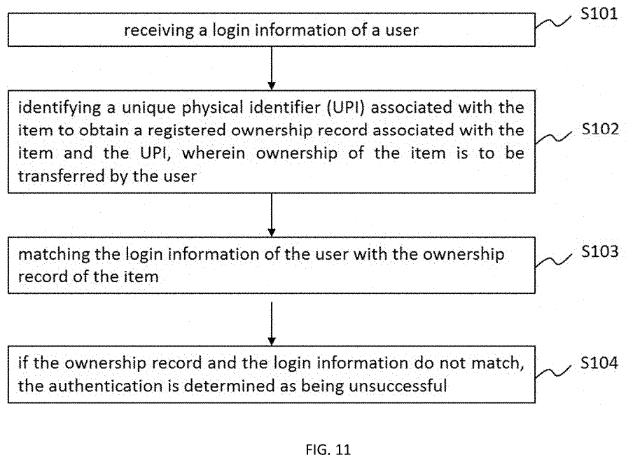

According to the first aspect of the embodiments of the present invention, a method of authenticating an item is provided, as shown in FIG. 11 the steps comprising:

S101 receiving a login information of a user;

S102 identifying a unique physical identifier (UPI) associated with the item to obtain a registered ownership record associated with the item and the UPI, wherein ownership of the item is to be transferred by the user; and

S103 matching the login information of the user with the ownership record of the item;

S104 if the ownership record and the login information do not match, the authentication is determined as being unsuccessful.

In one or more embodiments, if the authentication is determined as being unsuccessful, the method further comprises sending an alert to an owner of the item as registered in the ownership record; receiving ownership credential from the user; and adding the ownership credential to the ownership record such that the ownership record and the login information match.

In one or more embodiments, if the authentication is determined as being unsuccessful, the method further comprises searching, in a system database, to determine whether the item has been reported lost; if the item has been reported lost in the system database, sending a notification to the user and notifies owner of the item as registered in the ownership record that the item has been found. If the item has not been reported lost in the system database, sending an alert to the owner of the item as registered in the ownership record, receiving ownership credential from the user; and adding the ownership credential to the ownership record such that the ownership record and the login information match.

In one or more embodiments, if the ownership record and the login information match, the method further comprises adding ownership information of a new owner to the registered ownership record of the item, such that the new owner becomes current owner of the item.

In one or more embodiments, the UPI of the item is registered through steps comprises of generating the UPI according to type of physical identification information associated with the item and associating the UPI with the item being registered; generating, based on the UPI, a new product information data block corresponding to the item being registered and permanently storing the new product information data block in a registry used for recording ownership history of the item.

In one or more embodiments, the ownership record of the item that associated with the UPI is registered through steps comprises of receiving, from the user, a registration request; obtaining, from the user, item information associated with the UPI; generating the UPI according to type of physical identification information associated with the item and the item information, and associating the UPI with the item being registered; generating, based on the UPI, a new product information data block corresponding to the item being registered and ownership of the user and permanently storing the new product information data block in a registry used for recording ownership history of the item.

In one or more embodiments, the UPI comprise QR code, RFID or product serial number.

In one or more embodiments, the ownership record of the item is stored in a block chain, each ownership history forms an ownership chain.

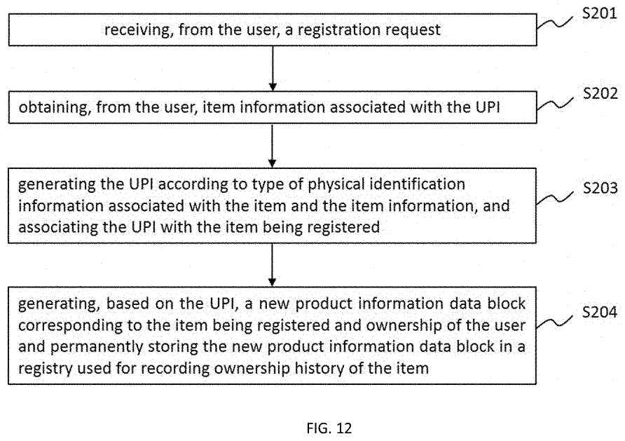

According to the second aspect of the present invention, a method of registering items is provided, as shown in FIG. 12, the steps comprising:

S201 receiving, from a user, a registration request;

S202 obtaining, from the user, item information associated with a unique physical identifier (UPI);

S203 generating the UPI according to type of physical identification information associated with the item and the item information and associating the UPI with the item to be registered;

S204 generating, based on the UPI, a new product information data block corresponding to the item to be registered and ownership of the user and permanently storing the new product information data block in a registry used for recording ownership history of the item.

According to the third aspect of the present invention, a system of authenticating items is provided, comprises an item, a login information from a user; a unique physical identifier (UPI) associated with the item to obtain a registered ownership record associated with the item and the UPI, wherein ownership of the item is to be transferred by the user; a computer for matching the login information of the user with the ownership record of the item and for determining the authentication is unsuccessful if the ownership record and the login information do not match.

According to the fourth aspect of the present invention, a computer readable storage medium is provided. The storage medium stores a computer program, when the computer program is being executed any one of the methods described above is implemented

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method of authenticating an item, the method comprising
receiving a login information of a user;
identifying a unique physical identifier (UPI) associated with the item to obtain a registered ownership record associated with the item and the UPI, wherein ownership of the item is to be transferred by the user; and
matching the login information of the user with the ownership record of the item for authentication of the item; wherein if the ownership record and the login information do not match, the authentication is determined as being unsuccessful.

2. The method of claim 1, wherein if the authentication is determined as being unsuccessful, the method further comprising steps of:
sending an alert to an owner of the item as registered in the ownership record;
receiving ownership credential from the user; and
adding the ownership credential to the ownership record such that the ownership record and the login information match.

3. The method of claim 1, wherein if the authentication is determined as being unsuccessful, the method further comprising steps of:
searching, in a system database, to determine whether the item has been reported lost;
if the item has been reported lost in the system database, sending a notification to the user which notifies the owner of the item as registered in the ownership record that the item has been found; and
if the item has not been reported lost in the system database, sending an alert to the owner of the item as registered in the ownership record, receiving ownership credential from the user; adding the ownership credential to the ownership record such that the ownership record and the login information match.

4. The method of claim 1, wherein if the ownership record and the login information match, the method further comprises: adding ownership information of a new owner to the registered ownership record of the item, such that the new owner becomes current owner of the item.

5. The method of claim 1, wherein the UPI of the item is registered through steps comprising: generating the UPI according to physical identification information associated with the item; associating the UPI with the item being registered; generating, based on the UPI, a new product information data block corresponding to the item being registered; and permanently storing the new product information data block in a registry used for recording ownership history of the item.

6. The method of claim 1, wherein the ownership record of the item associated with the UPI is registered through steps comprising:
receiving, from the user, a registration request;
obtaining, from the user, item information associated with the UPI;
generating the UPI according to physical identification information associated with the item and the item information, associating the UPI with the item being registered; and
generating, based on the UPI, a new product information data block corresponding to the item being registered and ownership of the user and permanently storing the new product information data block in a registry used for recording ownership history of the item.

7. The method of claim 5, wherein the UPI comprises a QR code, a RFID, or a product serial number.

8. The method of claim 5, wherein the ownership record of the item is stored in a blockchain, each ownership history forming an ownership chain.

9. The method of claim 1, wherein the step of receiving is performed by a first computer and wherein the steps of identifying and matching are performed by a second computer.

10. The method of claim 9, wherein the first computer is a smartphone or a mobile tablet.

11. The method of claim 9, wherein the second computer includes a blockchain network.

12. A method of registering an item comprises the steps of:
providing the item;
receiving, by a first computer and from a user, a registration request;
obtaining, from the user, item information associated with a unique physical identifier (UPI);
generating, by a second computer, the UPI according to physical identification information associated with the item and the item information and associating the UPI with the item to be registered;
generating, by the second computer and based on the UPI, a new product information data block corresponding to the item to be registered and ownership of the user and permanently storing the new product information data block in a registry used for recording ownership history of the item.

13. A system for authenticating an item, comprising:
the item;
a login information from a user;
a unique physical identifier (UPI) associated with the item to obtain a registered ownership record associated with the item and the UPI, wherein ownership of the item is to be transferred by the user; and
a computer for matching the login information of the user with the ownership record of the item and for determining the authentication is unsuccessful if the ownership record and the login information do not match.
